(19) United States
(12) Patent Application Publication
(10) Pub. No.: US 2002/0100373 A1
(43) Pub. Date: Aug. 1, 2002

(54) Apparatus for dehusking small fruits

(76) Inventors: Bernard Granger, Saint-Jean-sur-Richelieu (CA); Roger Chagnon, Saint-Mathias-sur Richelieu (CA); Benoit Lacasse, Saint-Jean-sur-Richelieu (CA); Sylvain Fortin, Mont St-Gregoire (CA)

Correspondence Address: Roger Chagnon, Horticultural R&D Centre, 430 Gouin Blvd, St-Jean-sur-Richelieu, QC, J3B 3E6, CA

(21) Appl. No.: 09/772,350

(22) Filed: Jan. 31, 2001

(51) Int. Cl. A23N 5/00; A23N 7/00; A47J 17/00; A47J 43/00

(52) U.S. Cl. 99/585; 99/575

(57) ABSTRACT

An apparatus for dehusking small fruits uses water and pinching rollers to tear off the husk.

### BACKGROUND OF THE INVENTION

The invention is a dehusking apparatus optimized for small fruits with soft husk.

1. Field of the Invention

The invention relates to dehusking machines in general but more particularity to dehusking machines adapted to small fruits with a soft husk.

2. Description of the Relevant Art

A number of machines have been developed over the years to dehusk a variety of fruits and vegetables. For example, patent 5,169,663 by Rossi et al is for partially dehusking corn and patent 4,708,056 by Chandra is for dehusking coconuts. More related to this application is a paper from the Agricultural Department of the University of Hawaii by Jaw Kal Wang entitled “Equipment for Dehusking Poha Berries” published in December 1966. Poha berries are small fruits covered with a soft husk that is preferably removed. Although related, because of the nature of the husk and the fruit itself, the apparatus of this instant invention requires a substantially different method for removal of the husk.

### SUMMARY OF THE INVENTION

The purpose of this invention is to provide a practical dehusker for a special kind of husk covered berries.

It is an object of the invention to provide a means of feeding the dehusker with a control flow of fruits for efficient dehusking.

It is another object of the invention to condition the husk of the fruit so that it is best suited for dehusking.

It is yet another object of the invention to cleanly and rapidly dehusk fruits with little damage to said fruits.

Finally, it is an object of the invention to cleanly and rapidly dehusk fruits with as much a yield as possible.

To accomplish that, this invention has an inclined conveyor belt with pickers that bring up in orderly fashion a number of fruits for conditioning by water, once wet, the fruits are pressed by another conveyor like means onto a pair of rollers that pinch the wet husk and tears it apart, after which, the dehusked fruits roll off into a collector bin.

### DESCRIPTION OF THE DRAWINGS

FIG. 1 Is a perspective view of the invention in general.

FIG. 2 Is a side view showing the detail of the pressure belt in relation with the pinching rollers.

FIG. 3 Is a side view of the pinching rollers.

### DETAILED DESCRIPTION OF THE PREFERRED EMBODIMENT

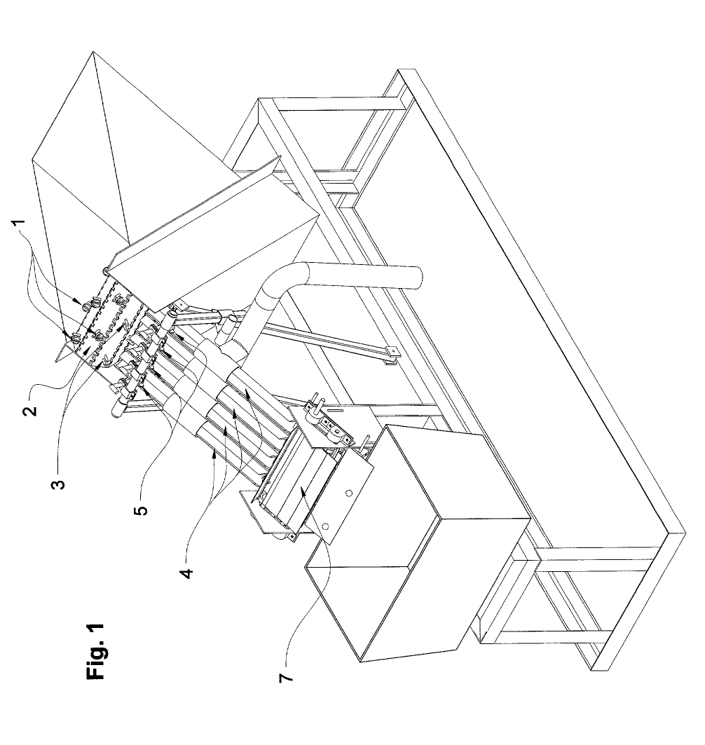

FIG. 1 The fruits 1 are delivered onto an elevating conveyor 2 and said elevating conveyor 2 has a series of pegs 3 set in staggered pairs along its length. The purpose of the pegs 3 is to pick up fruits 1 individually, lift them up and let them fall into one of several chutes 4. This way, the fruits 1 are delivered in an orderly manner and pace which facilitates further processing. Once in the chute 4 the fruits 1 are sprayed with water coming out of water jets 5 and then continue their slide until they go underneath the pressure belt 7.

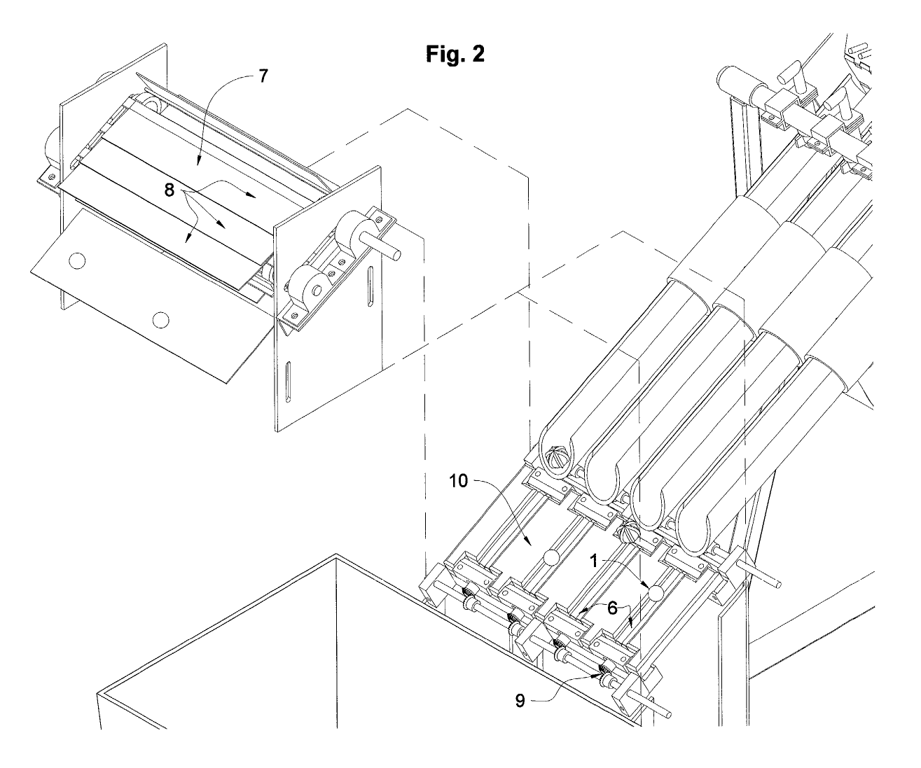

FIG. 2 The pressure belt 7, which is comprised of a series of interlinked flaps 8 exerts appropriate pressure onto the fruits 1 so that they can be captured by the pinching rollers 6 lying directly underneath, pinching rollers 6 come in pairs and the fruits are actually sandwiched between the pressure belt 7 and the pinching rollers 6. The said pressure plate 7 also controls the speed at which the fruits 1 pass over the pinching rollers 6 and each one of each pair of pinching rollers 6 is driven individually by its own driving mechanism 9 which is shared by other of its group. For example: each pinching roller 6 on the leftmost side of each pair would share a common driving mechanism 9 with each of the other leftmost pinching rollers 6 of the other pairs and each rightmost pinching roller 6 of each pair would share a driving mechanism 9 with the other rightmost pinching rollers 6 of the other pairs. The preferred embodiment is to have a common driving mechanism 9 that is at one tip of the pinching rollers 6 that handles all the leftmost pinching rollers 6 and a similar common driving mechanism which is situated at the opposite tip of the pinching rollers 6. The pressure belt 7 ensures that the fruits 1 are properly pressed against said pinching rollers 6.In order for the fruits 1 to be properly positioned upon the rollers 6 and to limit the amount of stray berries or stray husks to jam the machine and hinder the process, positioning blocks 10 are set between the pinching roller 6 pairs. Said positioning blocks 10 are generally higher that the height of the pinching rollers 6 to accomplish their positioning function.

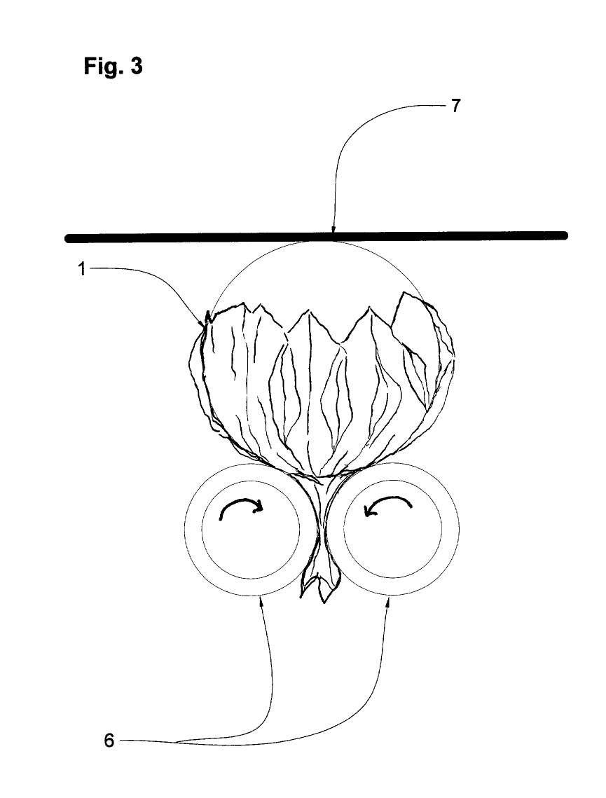

FIG. 3 The pinching rollers 6 operate in oppositely rotating pairs (along arrows directions). Speed and pressure are crucial in getting as many fruits 1 as possible to be pinched by the pinching rollers 6. Proper pinching of the husk results in its removal. That, along with the prior wetting of the husk and the action of the pressure belt 7 results in optimal husk removal in the case of the particular type of berries this instant invention was developed for (in the case of Poha berries, as per the Hawaii agriculture department document cited prior, cinging the husk worked better).

1. An apparatus for dehusking small fruits is comprised of
an elevating conveyor which is itself comprised of a series of pegs set in staggered pairs along the length of its conveyor belt part and said pegs pick up fruits one at a time and drop them down one or more chutes and said fruits are delivered in an orderly manner and pace which facilitates further processing which includes being sprayed with water and being sandwiched between pinching rollers and a pressure belt, the pressure belts pressures the fruits against the pinching rollers which causes the husk around the said fruit to be removed.

2. An apparatus for dehusking small fruits as described in claim 1 is comprised of
a pressure belt comprised of a series of interlinked flaps and said interlinked flaps use rubberlike materials for the flexible part of said pressure belt and metal parts for the rigid parts thereof.

3. An apparatus for dehusking small fruits as described in claim 1 is comprised of
at least one pair of oppositely rotating pinching rollers generally cylindrical in shape and each of said pinching rollers has its own driving mechanism.

4. An apparatus for dehusking small fruits as described in claim 1 is comprised of
at least one pair of oppositely rotating pinching rollers generally cylindrical in shape and each of said pinching rollers has its own driving mechanism and each said rollers has a metal core surrounded by a flexible, compressible rubberlike coating.

5. An apparatus for dehusking small fruits as described in claim 1 is comprised of
at least one pair of oppositely rotating pinching rollers generally cylindrical in shape and each of said pinching rollers has its own driving mechanism and each of said rollers has a metal core surrounded by a flexible, compressible rubberlike coating and said pinching rollers rotate at between 400 RPM and 600 RPM.

6. An apparatus for dehusking small fruits as described in claim 1 is comprised of
at least one pair of oppositely rotating pinching rollers generally cylindrical in shape and each of said pinching rollers has its own driving mechanism and each of said rollers has a metal core surrounded by a flexible, compressible rubberlike coating and said pair of pinching rollers has a space between oppositely rotating rollers of 0.025 inches.
